(19) United States
(12) Patent Application Publication
(10) Pub. No.: US 2013/0080313 A1
(43) Pub. Date: Mar. 28, 2013

(54) ADKINS RESIDENTIAL HOME VALUATION ANALYZER (RHVA)

(71) Applicant: Troy Morris Adkins, II, New York City, NY (US)

(72) Inventor: Troy Morris Adkins, II, New York City, NY (US)

(21) Appl. No.: 13/245,051

(22) Filed: Sep. 26, 2011

(51) Int. Cl. G06Q 40/02

(52) U.S. Cl. 705/38

(57) ABSTRACT

Systems and methods generally disclosed in order to value real estate by constructing a comprehensive list of constant factor multiple ratios that express a relationship that should exist between household incomes and home prices, based on prevailing mortgage interest rates for a fixed rate loan, and the percentage of pre-tax household income that a real estate investor believes should be spent to cover the costs associated with a mortgage loan.

### BACKGROUND OF THE INVENTION

1. Field of the Invention

The invention relates generally to residential real estate valuation.

2. Description of the Related Art

Homeownership has been touted as the “American Dream” for many years by virtually everyone in the United States. Unfortunately, the first 10 years of the twenty-first century have illustrated that at the micro-level, many people do not have the financial skills that are required in order to determine if they can afford a specific home. In addition, at the macro-level, many people do not have the financial skills that are required in order to properly assess the pricing levels of homes in their community. As a result, there can be a significant disconnect between the price and value of a home. With these issues in mind, it is imperative that residential real estate investors have a residential real estate valuation tool that will help them address residential home valuation issues in an economical, efficient, and effective manner.

While conventional home valuation methods provide various approaches to valuing residential real estate, each of them requires a level of knowledge, skill, and experience that is typically above the characteristics of most residential real estate investors. Moreover, most methods typically fail to take into account the cost of debt financing for a mortgage loan as well as the percentage of household income that should be spent to repay the loan. As a result, there is a material need for a comprehensive residential real estate valuation tool that is accurate in methodology, simplistic in design, and likely to be used by both novice and knowledgeable residential real estate investors to assist them with their home valuation process. Based on these needs, the Adkins' Residential Home Valuation Analyzer (RHVA) has been created.

### BRIEF SUMMARY OF THE INVENTION

In one aspect, systems and methods generally disclosed in order to value real estate by constructing a comprehensive list of constant factor multiple ratios that express a relationship that should exist between household incomes and home prices, based on prevailing mortgage interest rates for a fixed rate loan, and the percentage of pre-tax household income that a real estate investor believes should be spent to cover costs associated with a mortgage loan.

In another aspect, the Adkins' Residential Home Valuation Analyzer (RHVA) pertains to systems, processes, and methods that are designed to assist a residential real estate investor in analyzing a residential real estate investment, by taking into account household income, mortgage loan interest rates, and home prices, for purposes of: 1) determining the largest amount of money that the real estate investor should spend in order to purchase a home; 2) determining how much money the real estate investor would need to make in order to be able to afford a specific home; 3) helping the real estate investor determine if homes in the community are underpriced, fairly priced, or overpriced; and 4) helping the real estate investor determine the magnitude in which homes may be underpriced or overpriced in a specific community.

RHVA is a financial methodology that simplifies the residential home valuation process. RHVA simplifies the residential home valuation process by providing a table of factor multiples that expresses the relationship that should exist between pre-tax household income and home prices, by taking into account the prevailing interest rate for a 30-year fixed rate loan, and the percentage of pre-tax household income that the real estate investor believes should be spent in order to cover the costs associated with a mortgage loan.

RHVA offers many advantages to the residential real estate valuation process. These advantages include the fact that: 1) it is grounded in financial logic; 2) it utilizes an intuitive valuation process that is user friendly; 3) it allows a residential real estate investor to determine the largest amount of money that should be spent on a home; 4) it allows a residential real estate investor to determine the amount of household income that would need to be made on an annual basis in order to be able to afford a specific home; 5) it allows a residential real estate investor to determine if homes in a specific community are underpriced, fairly priced, or overpriced; 6) it allows a residential real estate investor to determine the magnitude of underpricing or overpricing of residential homes in a community; 7) it requires a minimal amount of effort by the user in order to develop a comprehensive and accurate real estate valuation; 8) it is a product that can be easily marketed, sold, and distributed to the general public; 9) it will be sold to the general public at a very affordable price; and 10) it is designed in a manner that is timeless in terms of financial methodology, which means that the RHVA methodology set forth in this patent application will serve as a valid methodology for future generations of residential real estate investors.

### BRIEF DESCRIPTION OF THE SEVERAL DRAWINGS OF THE INVENTION

FIG. 1 illustrates one exemplary methodology used to derive the Factor Multiples in the Adkins' Residential Home Valuation Analyzer (RHVA).

FIG. 2 illustrates one exemplary RHVA methodology that is used by the residential real estate investor in order to determine the largest amount of money that the residential real estate investor should spend on a home.

FIG. 3 illustrates one exemplary RHVA methodology that is used by the residential real estate investor in order to determine how much money the residential real estate investor would need to make in order to be able to afford a specific home.

FIG. 4 illustrates one exemplary RHVA methodology that is used by the residential real estate investor in order to determine if homes are underpriced, fairly priced, or overpriced in a specific community.

FIG. 5 illustrates one exemplary RHVA methodology that is used by the residential real estate investor in order to gauge the level of underpricing or overpricing of homes in a residential housing market.

### DETAILED DESCRIPTION OF THE INVENTION

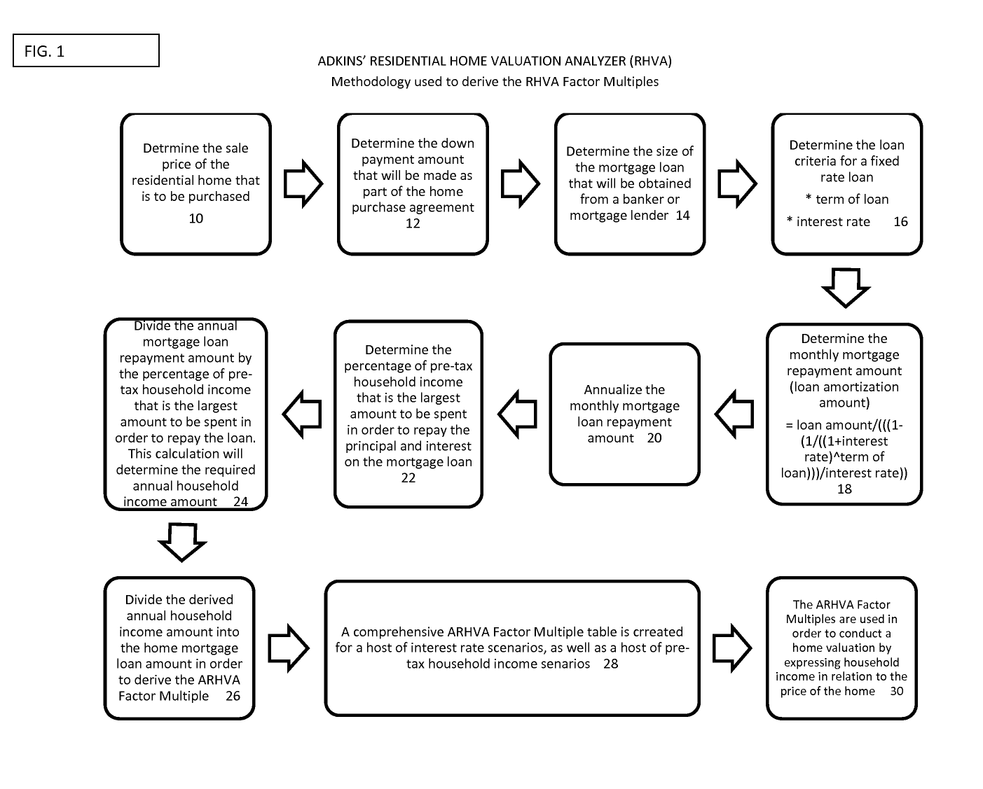

FIG. 1 illustrates one exemplary methodology used to derive the Factor Multiples in an Adkins Residential Home Valuation Analyzer (RHVA). The methodology outlined in FIG. 1 is a detailed description of the financial engine that drives the RHVA methodology, process, and system.

The embodiment of FIG. 1 provides a detailed explanation of the RHVA methodology in flow chart format. RHVA is a financial tool that simplifies the residential real estate valuation process. RHVA allows a real estate investor to determine: 1) the largest amount of money that should be spent in order to purchase a home; 2) the amount of household income that would need to be made on an annual basis in order to be able to afford a specific home; 3) if homes in a specific community are underpriced, fairly priced, or overpriced; and 4) the magnitude of the underpricing or overpricing of homes in a residential housing market.

One embodiment of RHVA runs on Microsoft Excel. Microsoft Excel is useful as the software platform for RHVA as the people that are most likely to utilize RHVA are individuals that prefer to value residential real estate from a financial perspective. Since it is highly likely that most of these people already know how to use Microsoft Excel, the learning curve for the individuals that elect to utilize RHVA should be minimal. Nevertheless, the streamlined structure of the RHVA methodology makes RHVA an ideal residential housing valuation tool for novice investors as well. With that in mind, it is fair to assume that RHVA has been designed in a manner that will allow real estate investors that have limited knowledge, skills, and experience to make a high quality, and accurate assessment of the residential real estate environment in their community.

The foundation of the RHVA Factor Multiple methodology is based on financial logic that simplifies the residential home valuation process. The RHVA methodology incorporates a host of variables into a systematic calculation in order to generate a table of RHVA Factor Multiples. The variables that are incorporated into the RHVA Factor Multiple calculation include home prices, mortgage loan interest rates, a loan amortization time horizon of 30 years, the methodology associated with amortizing a fixed-rate fully amortized loan, and the real estate investor's assumption about the percentage of pre-tax household income that should be spent in order to cover the cost of the mortgage loan. With this information, a comprehensive RHVA Factor Multiple table has been developed in order to provide real estate investors with a quick source methodology that can be used in order to analyze real estate investment opportunities in an economical, efficient, and effective manner.

The comprehensive RHVA Factor Multiple table provides factor multiples for interest rate scenarios that range from 1% to 20%. In addition, a Factor Multiple is generated for each interest rate environment that corresponds with a five basis point (0.0005) interval between 1% and 20%. Moreover, the RHVA Factor Multiple table allows a real estate investor to examine residential real estate investment opportunities for scenarios that would require a percentage of pre-tax household income that falls in the range of 20% and 75%. A Factor Multiple for the pre-tax household income scenarios is generated for each 100 basis point (0.01) interval between 20% and 75%. A summary of the range of scenarios in which an RHVA Factor Multiple has been determined is included in shaded format in the table below.

SUBSET OF THE COMPREHENSIVE ARHVA FACTOR MULTIPLE
TABLE

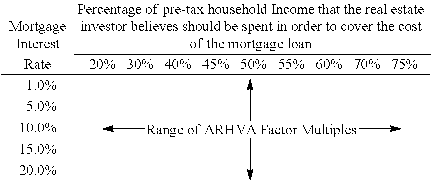

The RHVA Factor Multiple methodology is grounded in the use of the conventional fixed rate annuity payment formula that is readily available to the public. FIG. 1, Steps 10, 12, 14, and 16 show that the fixed rate annuity payment formula is used in order to calculate the monthly payment for a fixed rate loan. In order to make this calculation, the fixed rate annuity payment formula requires the dollar amount of the mortgage loan, the term of the mortgage loan, and the interest rate for the mortgage loan.

In one embodiment of FIG. 1, Step 18, the system uses the following formula in order to determine the monthly mortgage loan payment amount:

$$Monthly Mortgage Payment = \frac{Mortgage Loan Amount ( M L A )}{[ [ 1 - [ \frac{1}{{( 1 + i )}^{t}} ] ] / i ]}$$

where:

MLA=mortgage loan amount (home purchase price less down payment amount)

i=interest rate expressed in monthly terms (e.g. 5.0% APR/12=0.004166667)

t=time horizon expressed in monthly terms (i.e. 30 years=360 months)

In order to calculate the RHVA Factor Multiples, the following steps are implemented: First, use the monthly mortgage payment formula above in order to calculate the monthly mortgage payment amount for a loan (FIG. 1, step 18).

Second, the system multiplies the monthly mortgage payment amount times 12 in order to annualize the monthly payment amount (FIG. 1, step 20);

Third, the system divides the annual mortgage payment amount by the percentage of pre-tax household income that is believed to be the largest amount that should be spent in order to cover the cost of the mortgage loan. This step is required in order to determine the annual salary that would be required in order to cover the cost of the mortgage loan (FIG. 1, Steps 22 and 24); and

Fourth, the system divides the mortgage loan amount by the calculated annual salary amount in order to determine the RHVA Factor Multiple (FIG. 1, step 26).

A summary of these steps is included in the RHVA Factor Multiple formula below.

RHVA Factor Multiple Calculation Methodology

$$ARHVA Factor Multiple = \frac{Home Loan Amount}{( \frac{Monthly Mortgage Loan Repayment Amount * 12}{ \begin{matrix}\% of Pre \text{-} Tax Household \\ Income Spent on the Mortgange Loan\end{matrix} } )}$$

Fifth, ARHVA then repeats FIG. 1, Steps 10-26 in order to develop a comprehensive RHVA Factor Multiple table. While these steps have been repeated in order to encompass a broad interest rate environment of scenarios that range from 1% to 20%, and for scenarios of pre-tax household income that range from 20% to 75%, both of these ranges could be further expanded, if needed (FIG. 1 Step 28).

Sixth, the RHVA Factor Multiples are used to value a home (FIG. 1, Step 30).

Based on the methodology outlined above, the following four examples illustrate the use of the RHVA Factor Multiple methodology for purposes of providing a residential real estate valuation assessment.

### EXAMPLE I

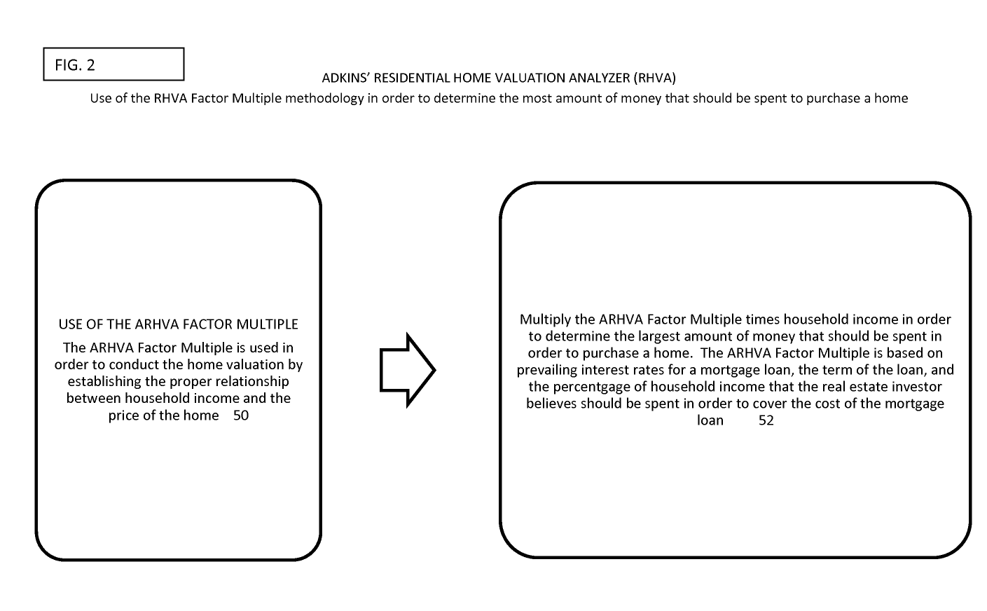

FIG. 2 illustrates one exemplary RHVA Factor Multiple methodology that is used in order to determine the largest amount of money that the residential real estate investor should spend on a home. This process is based on the prevailing interest rates for a mortgage loan, the term of the loan, and the percentage of household income that the residential real estate investor believes should be spent in order to cover the cost of the mortgage loan.

FIG. 2, Step 50 illustrates the first use of the RHVA methodology. To begin the process, assume that the prevailing mortgage interest rate for a 30-year fixed rate loan in the real estate investor's area is 5.0%, assume that the real estate investor's pre-tax household income is $50,000, and assume that the real estate investor believes that no more than 40% of pre-tax household income should be spent in order to cover the cost of the mortgage loan. In order to determine the largest amount of money that the real estate investor should spend for a home, review the RHVA Factor Multiple table below, and triangulate the two variables in order to find the RHVA Factor Multiple. For example, in this case, the RHVA Factor Multiple would be 6.2, because 6.2 is the RHVA Factor multiple that triangulates a 5.0% interest rate with the assumption of 40% of pre-tax household income. With this information, the real estate investor simply has to multiply 6.2*$50,000, which equals $310,000. Therefore, $310,000 is the most amount of money that the real estate investor should pay for a home (FIG. 2, Step 52).

SUBSET OF THE COMPREHENSIVE ARHVA FACTOR MULTIPLE
TABLE

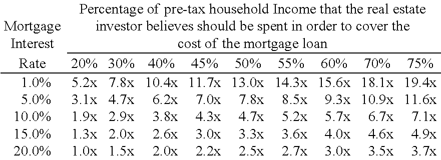

Note:
The table above is a truncated version of the comprehensive RHVA Factor multiple table.

### EXAMPLE II

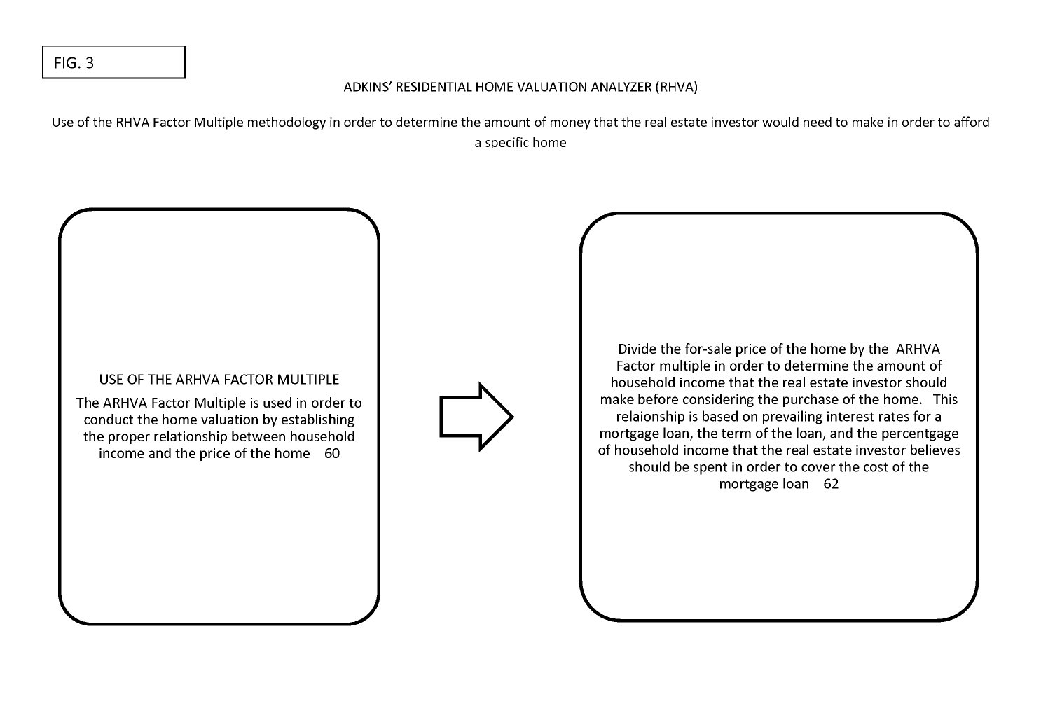

FIG. 3 illustrates one exemplary RHVA methodology that is used in order to determine how much money the real estate investor would need to make on an annual basis in order to be able to afford a specific home. This process is based on the prevailing interest rates for a mortgage loan, the term of the loan, and the percentage of household income that the residential real estate investor believes should be spent in order to cover the cost of the mortgage loan.

FIG. 3, Step 60, illustrates the second use of the RHVA methodology, where the factor multiple is used to conduct a home valuation. To utilize this process, the system divides the for-sale price of the home by the RHVA Factor Multiple in order to determine the annual household income that the real estate investor should make before considering the purchase of the home.

In one example, assume that the prevailing mortgage interest rate for a 30-year fixed rate loan in the real estate investor's area is 10.0%, assume that the real estate investor's pre-tax household income is $80,000, assume that the real estate investor believes that no more than 55% of pre-tax household income should be spent in order to cover the cost of the mortgage loan, and assume that the real estate investor finds a home that is for sale for $500,000. In order to determine how much money the real estate investor would need to make in order to afford the home, review the RHVA Factor Multiple table below, and triangulate the two variables in order to find the RHVA Factor Multiple. In this example, the RHVA Factor Multiple would be 5.2, which corresponds with an interest rate of 10% and an assumption that 55% of pre-tax household is an appropriate amount to spend in order to cover the cost of a mortgage loan.

Now, with this information, the real estate investor would divide the for-sale price of the home by the RHVA Factor Multiple, which in this case would be $500,000/5.2, which equals $96,154. Therefore, $96,154 is the amount of annual household income that the real estate investor would need to make in order to be able to afford the home.

Given this information, the real estate investor would conclude that the home should not be purchased, because the minimum household income amount was not met (i.e. $80,000 actual household income versus $96,154 required household income) (FIG. 3, step 62).

SUBSET OF THE COMPREHENSIVE ARHVA FACTOR MULTIPLE
TABLE

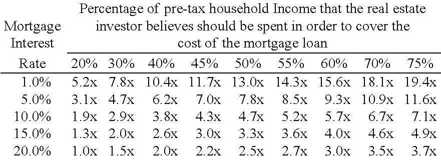

Note:
The table above is a truncated version of the comprehensive RHVA Factor multiple table.

### EXAMPLE III

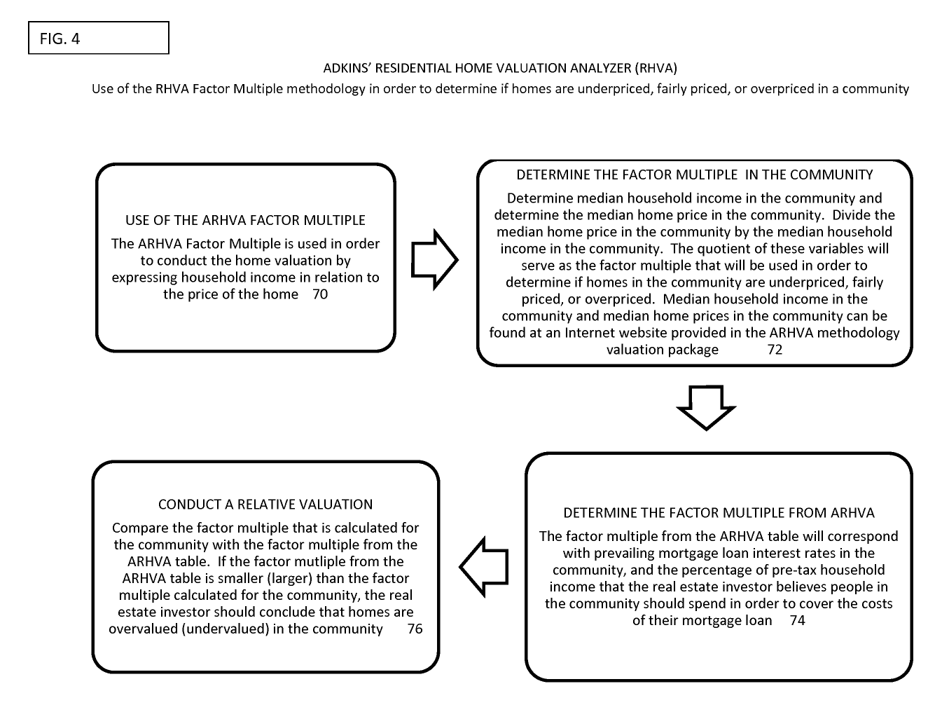

: FIG. 4 illustrates one exemplary RHVA methodology that is used by the residential real estate investor in order to determine if homes are underpriced, fairly priced, or overpriced in a specific community. This use of the RHVA methodology is based on the prevailing interest rates for a mortgage loan, the term of the loan, and the percentage of household income that the residential real estate investor believes should be spent in order to cover the cost of the mortgage loan.

In order to complete this stage of the RHVA analysis, the real estate investor will also need to obtain the median household income and the median home price in the community in order to conduct a relative valuation analysis. For purposes of determining median household income and median home price information, a public internet website is disclosed in the RHVA methodology package.

FIG. 4, Step 70, shows a use where the factor multiple is utilized in order to conduct a home valuation by expressing household income in relation to the price of a home. In order to utilize this process, the system determines the factor multiple in the community. In this example of the RHVA methodology, assume that the real estate investor lives in New York City, assume that the median household income in New York City is $70,000, and assume that the median home or condo price in New York City is $700,000. Now, based on this information, the factor multiple for New York City would be $700,000/$70,000, which is 10.0. Again, for purposes of determining median household income and median home price information, a public internet website is disclosed in the RHVA methodology package. Therefore, a factor multiple of 10.0 should be used as the benchmark for New York City (FIG. 4 Step 72).

Let us now assume that the prevailing mortgage interest rate for a 30-year fixed rate loan in New York City is 4.45%, and let us assume that the real estate investor believes that no more than 35% of pre-tax household income should be spent in order to cover the cost of the mortgage loan. Based on this information, the RHVA Factor Multiple, as obtained from the RHVA Factor Multiple table below, is 5.79 (FIG. 4, Step 74).

In the last step, the system determines if the home is underpriced or not. Based on this example analysis, the real estate investor would conclude that homes are significantly over priced in New York City, because the calculated factor multiple of 10.0 is significantly larger than the RHVA Factor Multiple of 5.79 (FIG. 4, Step 76).

SUBSET OF THE COMPREHENSIVE ARHVA FACTOR MULTIPLE
TABLE

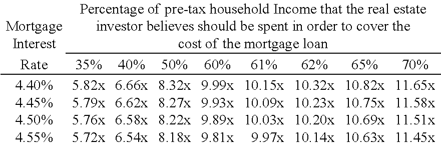

Note:
The table above is a truncated version of the comprehensive RHVA Factor multiple table.

### EXAMPLE IV

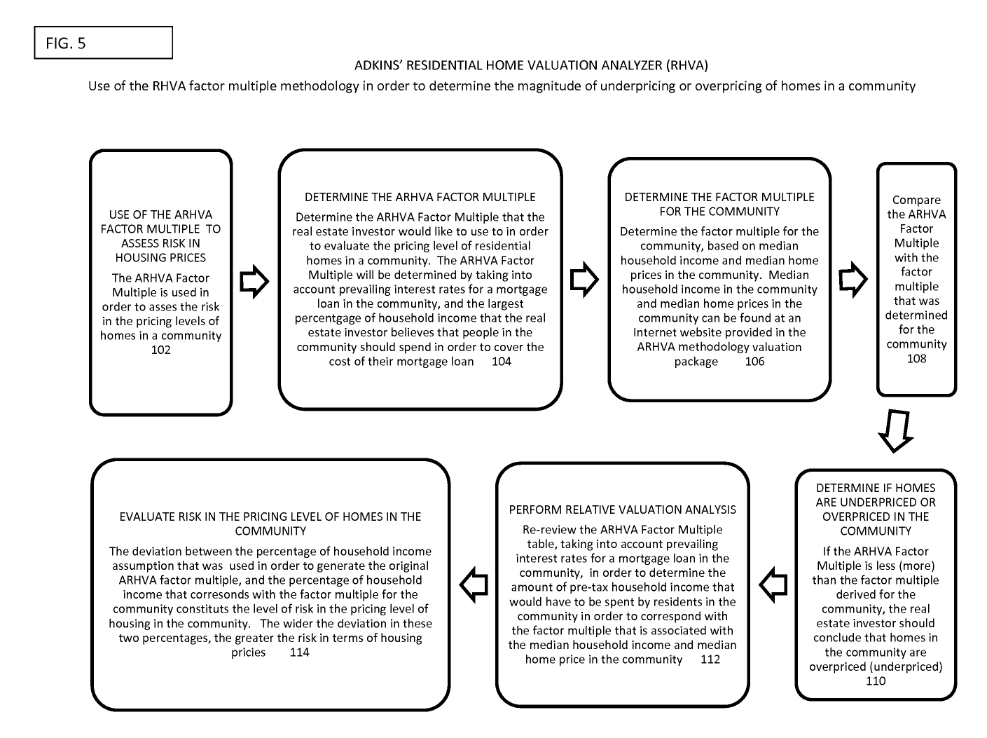

FIG. 5 shows one exemplary use of the RHVA Factor Multiple methodology that is used in order to determine the magnitude of underpricing or overpricing of residential homes in a community. This piece of the RHVA methodology is based on the prevailing interest rates for a mortgage loan, the term of the loan, and the percentage of household income that the residential real estate investor believes should be spent in order to cover the cost of the mortgage loan. In order to complete this stage of the RHVA analysis, the real estate investor will need to obtain the median household income and the median home price in the community in order to conduct a relative valuation analysis. Again, for purposes of determining median household income and median home price information, a public internet website is disclosed in the RHVA methodology package. Once this information has been obtained, the real estate investor can calculate a factor multiple for the community and determine the percentage of pre-tax household income that would be required in order to correspond with the factor multiple that is calculated for the community. This information would then be compared to the percentage of pre-tax household income that the real estate investor believes should be spent in order to cover the costs of the mortgage loan. In order to interpret the results, the real estate investor would assume that the larger the spread in these two percentages, the greater the risk in the pricing of housing in the community.

In FIG. 5, Step 102, a fourth use of the RHVA methodology is shown. To begin the process, assume that the real estate investor lives in San Francisco, assume that the prevailing mortgage interest rate for a 30-year fixed rate loan in San Francisco is 4.5%, and assume that the real estate investor believes that no more than 60% of pre-tax household income should be spent in order to cover the cost of a mortgage loan. Based on this information, the RHVA Factor Multiple, as obtained from the sample RHVA Factor Multiple table below is 9.87 (FIG. 5, Step 104). Next, the system determines the factor multiple for the community. Now, assume that the median household income in San Francisco is $50,000, and assume that the median home or condo price in San Francisco is $550,000. Based on this information, the calculated factor multiple for San Francisco would be $550,000/$50,000, which is 11.0 (FIG. 5, Step 106). The system then determines if the homes are undervalued or overvalued. Based on this exemplary analysis, the real estate investor would conclude that homes are slightly overpriced in San Francisco, because the actual factor multiple of 11.0, is slightly larger than the RHVA Factor Multiple of 9.87 (FIG. 5 Steps 108 and 110). With this information, the real estate investor can now gauge the risk in the San Francisco housing market, by determining the percent of pre-tax household income that would have to be spent in order to derive an RHVA Factor Multiple of 11.0. In this case, between 66% and 67% of pre-tax household income would be required in order to correspond with a 4.5% interest rate environment, and a factor multiple of 11.0. This information is illustrated in the shaded boxes in the table below (FIG. 5, Step 112).

Based on this methodology, the system helps the real estate investor evaluate risk in the pricing level of homes in the community. As a result, the real estate investor can better assess the risk of purchasing a home in San Francisco, and the likelihood of home prices depreciating, appreciating, or remaining constant in the community over time. For example, if the real estate investor is conservative, the real estate investor will likely reach the conclusion that homes are overpriced in San Francisco, and therefore purchasing a home in San Francisco will not likely lead to a profitable rate of return on investment over time. Moreover, even if the real estate investor is very aggressive, the real estate investor will likely reach the conclusion that it is not appropriate to purchase real estate in San Francisco, because the percentage of household income that would be required in order to justify a multiple of 11.0 is very high, and not likely to lead to a profitable investment decision, due to the large percentage of pre-tax household income that would have to be allocated by the people that live in San Francisco in order to cover the cost of their mortgage loan (FIG. 5, Step 114).

SUBSET OF THE COMPREHENSIVE ARHVA FACTOR MULTIPLE
TABLE

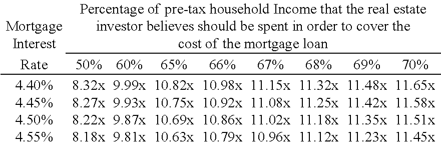

The factor multiple will be the same if the user is valuing a $100,000, $1,000,000, or $10,000,000 home. Thus, for any given interest rate, and any given assumption about the percentage of pre-tax household income that the real estate investor believes should be spent in order to cover the cost of the mortgage loan, the Factor multiple that triangulates these variables will be constant. For example, if the investor believes 40% is the maximum amount of pre-tax household income that should be spent to cover the cost of a mortgage loan, and s/he can obtain a 30-year fixed rate loan for 5.0%, the factor multiple will be 6.2. Therefore, if the investor makes $100K per year, s/he should not spend more than $620 k on a home. If s/he makes $1 million per year, s/he should not spend more than $6.2 million on a home. Moreover, if the investor looks at buying a home with an asking price of 1.5 million, s/he would need to make $241,935 per year, if s/he is looking at buying a home with a $350 k, s/he would need to make $56,452. The point being that 6.2× is a constant factor in these examples.

The invention may be implemented in hardware, firmware, or software, or a combination of the three. Preferably, the invention is implemented in a computer program executed on a programmable computer having a processor, a data storage system, volatile and non-volatile memory and/or storage elements, at least one input device and at least one output device.

Each computer program is tangibly stored in a machine-readable storage media or device (e.g., program memory or magnetic disk) readable by a general or special purpose programmable computer, for configuring and controlling the operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method to value real estate, comprising:
constructing a comprehensive list of constant factor multiple ratios that express a relationship that should exist between household incomes and home prices, based on prevailing mortgage interest rates for a fixed rate loan, and the percentage of pre-tax household income that a real estate investor believes should be spent to cover costs associated with a mortgage loan.

2. A method of claim 1, comprising determining the largest amount of money that should be spent on a home.

3. A method of claim 1, comprising determining the amount of household income that would need to be made on an annual basis in order to be able to afford a specific home.

4. A method of claim 1, comprising determining if homes in a specific community are underpriced, fairly priced, or overpriced.

5. A method of claim 1, comprising determining the magnitude of underpricing or overpricing of residential homes in a community.

6. The method of claim 1, comprising determining an interest rate available in a community for a fixed rate loan.

7. The method of claim 1, comprising determining a percentage of pre-tax household income that should be spent to cover costs of a mortgage loan.

8. The method of claim 1, comprising determining a monthly mortgage repayment amount as derived by the loan amount divided by (((1−(1/((1+interest rate)̂term of loan)))/interest rate)).

9. The method of claim 8, comprising annualizing the monthly mortgage repayment amount.

10. The method of claim 1, comprising dividing the annual mortgage loan repayment amount by a percentage of pre-tax household income in order to determine a required annual household income amount.

11. The method of claim 1, comprising dividing a required annual household income amount into the home mortgage loan amount in order to derive a valuation factor multiple.

12. The method of claim 1, comprising determining a comprehensive list of factor multiples for various mortgage loan interest rate scenarios and pre-tax household income assumptions.

13. The method of claim 1, wherein the Factor Multiples are used to conduct a residential real estate environment valuation by expressing household income in relation to the price of the home.

14. The method of claim 1, comprising conducting a residential real estate environment valuation.

15. A computer system to value real estate, comprising:
a processor; and
means for constructing a comprehensive list of constant factor multiple ratios that express a relationship that should exist between household incomes and home prices, based on prevailing mortgage interest rates for a fixed rate loan, and the percentage of pre-tax household income that a real estate investor believes should be spent to cover costs associated with a mortgage loan.

16. A system of claim 15, comprising means for determining the largest amount of money that should be spent on a home.

17. A system of claim 15, comprising means for determining the amount of household income that would need to be made on an annual basis in order to be able to afford a specific home.

18. A system of claim 15, comprising means for determining if homes in a specific community are underpriced, fairly priced, or overpriced.

19. A system of claim 15, comprising means for determining the magnitude of underpricing or overpricing of residential homes in a community.
